(19) United States
(12) Patent Application Publication
(10) Pub. No.: US 2014/0261377 A1
(43) Pub. Date: Sep. 18, 2014

(54) Barbecue apparatus

(71) Applicant: Kiosky Chung, Taichung City (TW)

(72) Inventor: Kiosky Chung, Taichung City (TW)

(21) Appl. No.: 13/833,011

(22) Filed: Mar. 15, 2013

(51) Int. Cl. A47J 37/07

(52) U.S. Cl. CPC A47J 37/0704
USPC 126/25 R

(57) ABSTRACT

A barbecue apparatus includes a casing, a cover, two cooking grills, two handles, two warming grills, an axle and two supporting elements. The casing includes two lateral walls, a rear wall formed between the lateral walls, and two hooks formed on the rear wall. Each lateral wall includes a recess defined therein. The cover is pivotally connected to the casing. Each cooking grill includes an aperture for receiving a corresponding hook so that the cooking grills are pivotally connected to the casing. Each handle extends out of a corresponding recess from a corresponding cooking grill. The axle is used to pivotally connect the warming grills to the cover. Each supporting element includes a beam pivotally connected to a corresponding warming grill, a pivot pivotally connected to a corresponding cooking grill and a post extending to the pivot from the beam.

### BACKGROUND OF INVENTION

1. Field of Invention

The present invention relates to a barbecue apparatus and, more particularly, to a barbecue apparatus good for cooking food and keeping it warm.

2. Related Prior Art

As disclosed in U.S. Pat. No. 3,520,290, a conventional grill 10 includes a casing 11, a cooking grate 20, a cover 25, a warming grate 29, two grate-supporting brackets 30, two attaching brackets 44, two guide arms 47 and two latches 51. The cooking grate 20 is placed in the casing 11. The cover 25 is pivotally connected to the casing 11. The warming grate 29 is detachably supported on the grate-supporting brackets 30. Each grate-supporting bracket 30 includes a base 33 connected to a groove element 37 by two posts 38 and 39. The base 33 of each grate-supporting bracket 30 is secured to the casing 12. Each attaching bracket 44 includes an aperture 44b defined therein and is attached to the cover 25. Each guide arm 47 includes a pin 49 secured thereto. Each latch 51 includes a notched end 51b. Each guide arm 47 is pivotally connected to a corresponding leg 39. Each latch 51 is pivotally connected to a corresponding guide arm 47. Each pin 49 is inserted through a corresponding aperture 44b. The notched end 51b of each latch 51 is engaged with a corresponding pin 49. Thus, the grate-supporting brackets 30 are extended to place the warming grate 29 horizontally for use when the cover 25 is lifted from the casing 11. The use of the grill 10 is not without any problems. To add coal into the casing 11 from time to time, the cooking grate 20 has to be removed or lifted from the casing 11. A user can remove food from the cooking grate 20 before he or she uses a hand to remove or lift the cooking grate 20 from the casing 11 and uses the other hand to add coal into the casing 11. Alternatively, the user can leave the food on the cooking grate 20 and use both hands to move the cooking grate 20 to a safe place from the casing 11 before he or she uses a hand to add coal into the casing 11. Both practices are inconvenient. Moreover, the addition of coal deep into a rear portion of the interior of the casing 11 is hindered by the warming grate 29.

As disclosed in U.S. Pat. No. 4,979,437, another conventional barbecue grill 12 includes a housing 16, a cover 18, a gas burner 20, a cooking grill 22, a lower warming rack 24, a lower U-shaped bail 25, an upper warming rack 26 and an upper U-shaped bail 34. The cover 18 is pivotally connected to the housing 16. The gas burner 20 is placed in and connected to the housing 16. The cooking grill 22 is placed in the housing 16. The lower warming rack 24 and the upper warming rack 26 are pivotally connected to the cover 18. The lower U-shaped bail 25 includes a lower portion pivotally connected to the housing 16 and an upper portion pivotally connected to the lower warming rack 24. The upper U-shaped bail 34 includes a lower portion movably connected to the lower warming rack 24 and an upper portion pivotally connected to the upper warming rack 26. Thus, the warming racks 24 and 26 are placed horizontally for use when the cover 18 is lift from the housing 16. This configuration is suitable for gas-burning grills, not for coal-burning grills. To add coal into the housing 16 from time to time, the cooking grill 22 has to be removed or lifted from the housing 16. However, the movement of the cooking grill 22 is hindered by the lower U-shaped bail 34. A user can remove food from the cooking grill 22 before he or she uses a hand to remove or lift the cooking grill 22 from the housing 16 and uses the other hand to add coal into the housing 16. Alternatively, the user can leave the food on the cooking grill 22 and use both hands to move the cooking grill 22 to a safe place from the housing 16 before he or she uses a hand to add coal into the casing 16. Moreover, the addition of coal deep into a rear portion of the interior of the housing 16 is hindered by the lower warming rack 24.

As disclosed in US Patent Application Publication 2006/0086354, another conventional grill 100 includes a housing 162, a cover 164, a cooking structure 170, a warming rack 110, two supports 120 and two mounting devices 130. The cover 164 is pivotally connected to the housing 162. The cooking structure 170 is placed in the housing 162. Each support 120 includes two legs 124 extending from a beam 126. Each leg 124 is pivotally connected to the cooking structure 170 by a corresponding mounting device 130. The warming rack 110 is connected to the beams of the supports 120. The use of the grill 100 is not without any problems. The lifting of the cover 164 from the housing 162 does not automatically place the warming rack 110 in an active position because the warming rack 110 is not connected to the cover 164. Therefore, a user has to lift the cover 164 before he or she can place the warming rack 110 in an active position. Moreover, to add coal into the housing 162 from time to time, the user has to remove all of the cooking structure 170, the warming rack 110, the supports 120 and the mounting devices 130 from the housing 162, and this could be a heavy load for the user. The user can remove food from the cooking structure 170 before he or she uses a hand to remove or lift the cooking structure 170, the warming rack 110, the supports 120 and the mounting devices 130 from the housing 162 and uses the other hand to add coal into the housing 162. Alternatively, the user can leave the food on the cooking structure 170 and the warming rack 110 and use both hands to move the cooking structure 170, the warming rack 110, the supports 120 and the mounting devices 130 to a safe place from the housing 162 before he or she uses a hand to add coal into the housing 162.

Therefore, the present invention is intended to obviate or at least alleviate the problems encountered in prior art.

### SUMMARY OF INVENTION

It is the primary objective of the present invention to provide a convenient barbecue apparatus.

To achieve the foregoing objective, the barbecue apparatus includes a casing, a cover, two cooking grills, two handles, two warming grills, an axle and two supporting elements. The casing includes two lateral walls, a rear wall formed between the lateral walls, and two hooks formed on the rear wall. Each of the lateral walls includes a recess defined therein. The cover is pivotally connected to the casing. Each of the cooking grills includes an aperture for receiving a corresponding one of the hooks so that the cooking grills are pivotally connected to the casing. Each of the handles extends out of a corresponding one of the recesses from a corresponding one of the cooking grills. The axle is used to pivotally connect the warming grills to the cover. Each of the supporting elements includes a beam pivotally connected to a corresponding one of the warming grills, a pivot pivotally connected to a corresponding one of the cooking grills and a post extending to the pivot from the beam.

Other objectives, advantages and features of the present invention will be apparent from the following description referring to the attached drawings.

### BRIEF DESCRIPTION OF DRAWINGS

The present invention will be described via detailed illustration of the preferred embodiment referring to the drawings wherein:

FIG. 1 is a perspective view of a barbecue apparatus in a closed position according to the preferred embodiment of the present invention;

FIG. 2 is a cross-sectional view of the barbecue apparatus taken along a line A-A shown in FIG. 1;

FIG. 3 is a perspective view of the barbecue apparatus in an open position other than shown in FIG. 1;

FIG. 4 is a cross-sectional view of the barbecue apparatus shown in FIG. 3;

FIG. 5 is a cross-sectional view of the barbecue apparatus taken along a line B-B shown in FIG. 2;

FIG. 6 is a cut-away view of two cooking grills of the barbecue apparatus shown in FIG. 3;

FIG. 7 is a perspective view of the barbecue apparatus in another position than shown in FIG. 3;

FIG. 8 is a perspective view of the warming grills of the barbecue apparatus in the position shown in FIG. 3; and

FIG. 9 is another perspective view of one of the warming grills shown in FIG. 8.

### DETAILED DESCRIPTION OF PREFERRED EMBODIMENT

Referring to FIGS. 1 to 4, there is shown a barbecue apparatus according to the preferred embodiment of the present invention. The barbecue apparatus includes a casing 10, a cover 20 and a hinge 30 for pivotally connecting the cover 20 to the casing 10.

The casing 10 includes a front wall 12, a rear wall 14 and two lateral walls 16 extending to the front wall 12 from the rear wall 14. The front wall 12 includes a shoulder 11 formed on an internal side thereof. Two hooks 13 are formed on an internal side of the rear wall 14. Each of the lateral walls 16 includes a recess 15 defined therein.

Referring to FIGS. 2 and 5, there are provided two resilient locks 17 for resiliently locking the cover 20 to the casing 10. Each of the resilient locks 17 includes a guiding portion 18 extending in a slant manner from an abutting portion 19 that extends vertically. The abutting portion 19 of each of the resilient locks 17 is secured to the corresponding wall 16 of the casing 10.

The cover 20 is formed with two lateral walls 24. The cover 20 is provided with a handle 22 for easy maneuvering thereof.

The hinge 30 includes an upper element 32, a lower element 34 and a pin 36. The upper element 32 is secured to the cover 20 by welding or rivets for example. The lower element 34 is secured to the casing 10 by welding or rivets for example. The lower element 34 is formed with a stop 38. The pin 36 is inserted in the upper element 32 and the lower element 34. Thus, the cover 20 is pivotally connected to the casing 10.

A user can maneuver the handle 22 to move the cover 20 between a closing position shown in FIGS. 1, 2 and 5 and an opening position shown in FIGS. 3 and 4. In the opening position, the cover 20 is lifted from the casing 10. The cover 20 is separated from the casing 10 by an angle larger than 90° when the upper element 32 of the hinge 30 is placed on the stop 38. Now, the center of weight of the cover 20 is placed adequately behind the pin 36. Thus, the cover 20 is firmly placed in the opening position.

In the closing position, the cover 20 is placed on the casing 10. The lateral walls 24 of the cover 20 are placed against the abutting portions 19 of the resilient locks 17. Thus, the cover 20 is resiliently locked to the casing 10 by the resilient locks 17.

In a final phase of the movement of the cover 20 into the closing position from the opening position, the lateral walls 24 of the cover 20 are smoothly brought into contact with the abutting portions 19 of the resilient locks 17 because the lateral walls 24 of the cover 20 are guided by the guiding portions 18 of the resilient locks 17.

The barbecue apparatus includes two cooking grills 40, two warming grills 50 and a linkage 60. The linkage 60 includes an axle 61 and two supporting elements 70. The axle 61 is used to pivotally connect the warming grills 50 to the cover 20. The supporting elements 70 are used to support the warming grills 50 on the cooking grills 40.

Each of the cooking grills 40 is pivotally connected to the casing 10. Each of the cooking grills 40 includes an aperture 41 defined in a rear portion thereof, an upper lug 42 extending upward from a first lateral portion thereof, a first lower lug 43 extending downward from the first lateral portion, and a second lower lug 43 extending downward from a second lateral portion. Each of the cooking grills 40 is pivotally connected to the casing 10 as the rear portion thereof is hooked by a corresponding one of the hooks 13, which is inserted in the aperture 41 thereof.

Each of the cooking grills 40 is provided with a handle 44 for easy maneuvering thereof. Each of the handles 44 includes a rod 45 inserted in a grip 46. The rod 45 of each handle 44 is inserted in and connected to the first lower lug 43 of the corresponding cooking grill 40. For example, the rod 45 includes a threaded portion driven in a screw hole defined in the first lower lug 43. The grip 46 is made of metal and includes two rings 47 and 48 fit on the rod 45 and arched strips 49 each extending between the rings 47 and 48. The arched strips 49 are used for radiation so that the user can hold the grips 46 without the risk of being burnt. The arched strips 49 may be replaced with fins in another embodiment. The grip 46 may be made plastics or rubber in another embodiment.

When the cooking grills 40 are placed in the casing 10, the grips 46 are placed out of the casing 10 and the rods 45 are inserted through the recesses 15. Hence, the closing of the casing 10 by the cover 20 is not interfered with by the handles 44.

Referring to FIG. 6, a connector 80 is used to connect the cooking grills 40 to each other. The connector 80 is a butterfly screw for example. The connector 80 can be driven in a screw hole defined in the second lower lug 43 of a cooking grill 40 through a smooth aperture defined in the second lower lug 43 of the other cooking grill 40.

Referring to FIG. 7, the cooking grills 40 can be moved independent of each other after the connector 80 is removed from the second lower lugs 43 thereof.

Each of the warming grills 50 includes crossbars 51, middle bars 52 and two lateral bars 53. The crossbars 51 extend parallel to one another. The middle bars 52 and the lateral bars 53 extend parallel to one another. The crossbars 51 extend perpendicular to the middle bars 52 and the lateral bars 53. The crossbars 51 are secured to the middle bars 52 and the lateral bars 53 by welding for example. Each of the lateral bars 53 includes a J-shaped portion 54 formed at a rear end and a U-shaped portion 55 formed near a front end.

The axle 61 includes a flat middle portion 63 formed between two terminal portions. A ring 62 is placed on each of the terminal portions of the axle 61 so that the flat middle portion 63 of the axle 61 is placed between the rings 62.

Each terminal portion of the axle 61 is inserted through the J-shaped portions 54 of the lateral bars 53 of the corresponding warming grill 50, placed against the middle bars 52, and inserted in the corresponding lateral wall 24 of the cover 20. Thus, the warming grills 50 are pivotally connected to the cover 20 by the axle 61. Each of the warming grills 50 is substantially not movable along the axle 61 as each of the warming grills 50 is confined between a corresponding one of the rings 62 and the corresponding lateral wall of the cover 20.

Referring to FIGS. 8 and 9, each of the supporting elements 70 includes two ends 72 and 74, a beam 71 and a post 73. The beam 71 extends perpendicular to the post 73. The first end 72 extends from the beam 71. The first end 72 extends parallel to the post 73. The second end 74 extends from the post 73. The second end 74 extends parallel to the beam 71. The second end 74 is used as a pivot and will be called “the pivot 74” hereinafter.

The beam 71 of each supporting element 70 is inserted through the U-shaped portions 55 of the lateral bars 53 of the corresponding warming grill 50 and placed against the middle bars 52 of the corresponding warming grill 50. Thus, the supporting elements 70 are pivotally connected to the warming grills 50.

The first end 72 of each supporting element 70 is placed against the U-shaped portion 55 of one of the lateral bars 53 of the corresponding warming grill 50. Thus, each supporting element 70 is kept to the corresponding warming grill 50.

The pivot 74 of each supporting element 70 is inserted in the upper lug 42 of the corresponding cooking grill 40. Thus, the supporting elements 70 are pivotally connected to the cooking grills 40.

Referring to FIGS. 1, 2 and 5, the cover 20 is placed in the closing position. The cover 20 is resiliently kept in the closing position by the resilient locks 17.

Referring to FIGS. 3 and 4, the cover 20 is placed in the opening position. The cover 20 is firmly placed in the opening position due to the use of the hinge 30 and, more particularly, the stop 38.

The warming grills 50 are automatically placed in an active position when the cover 20 is placed in the opening position. This is because of the use of the linkage 60 to connect the warming grills 50 to the cover 20 and the cooking grills 40.

When there is no food on any of the grills 40 and 50, the user can use the connector 80 to connect the cooking grills 40 to each other. The user can use the left hand to operate the left handle 44 to lift both of the left cooking grills 40 from the casing 10 and use the right hand to add coal into the casing 10. The coal can quickly be placed into the casing 10 without any interference from any of the grills 40 and 50.

When there is food on any of the grills 40 and 50, the user can remove the connector 80 form the cooking grills 40 as shown in FIG. 7. The user can move the food onto the right cooking grill 40 and/or the right warming grill 50 for example before he or she uses the left hand to hold the left handle 44 to lift the left cooking grill 40 from the casing 10 and uses the right hand to add coal into the casing 10. When the left cooking grill 40 is lifted from the casing 10, the left warming grill 50 is moved from the active position so that it is not placed above the casing 10. The cooking and/or warming of the food can continue during the addition of the coal into the casing 10.

The present invention has been described via the detailed illustration of the preferred embodiment. Those skilled in the art can derive variations from the preferred embodiment without departing from the scope of the present invention. Therefore, the preferred embodiment shall not limit the scope of the present invention defined in the claims.

1. A barbecue apparatus including:
a casing including two lateral walls, a rear wall formed between the lateral walls, and two hooks formed on the rear wall, wherein each of the lateral walls includes a recess defined therein;
a cover pivotally connected to the casing;
two cooking grills each including an aperture for receiving a corresponding one of the hooks so that the cooking grills are pivotally connected to the casing;
two handles each extending out of a corresponding one of the recesses from a corresponding one of the cooking grills;
two warming grills;
an axle for pivotally connecting the warming grills to the cover; and
two supporting elements each including a beam pivotally connected to a corresponding one of the warming grills, a pivot pivotally connected to a corresponding one of the cooking grills and a post extending to the pivot from the beam.

2. The barbecue apparatus according to claim 1, wherein each of the handles includes a rod extending out of the corresponding recess from the corresponding cooking grill and a grip placed on the rod.

3. The barbecue apparatus according to claim 2, wherein the grip includes arched strips connected to the rod.

4. The barbecue apparatus according to claim 3, wherein the grip includes two rings fit on the rod, wherein each of the arched strips includes two ends connected to the rings.

5. The barbecue apparatus according to claim 1, including at least one hinge for connecting the cover to the casing.

6. The barbecue apparatus according to claim 5, wherein the hinge includes a lower element secured to the casing, an upper element secured to the cover, and a pin inserted in the lower and upper elements.

7. The barbecue apparatus according to claim 6, wherein the lower element is formed with a stop for abutting the upper element when the cover is lifted from the casing.

8. The barbecue apparatus according to claim 7, wherein the upper element is abutted against the stop when the cover is separated from the casing by an angle larger than 90°.

9. The barbecue apparatus according to claim 1, wherein each of the warming grills includes:
middle bars substantially extending parallel to one another; and
two lateral bars substantially extending parallel to the middle bars and each including a J-shaped portion formed at an end, wherein the axle is placed on the J-shaped portions of the lateral bars and beneath the middle bars and connected to the cover.

10. The barbecue apparatus according to claim 9, wherein the axle includes a flat middle portion for abutting the J-shaped portion of one of the lateral bars of each of the warming grills.

11. The barbecue apparatus according to claim 10, including two rings each placed between the flat middle portion of the axle and the J-shaped portion of the corresponding lateral bar of the corresponding warming grill.

12. The barbecue apparatus according to claim 9, wherein each of the lateral bars includes a U-shaped portion, wherein the beam of each of the supporting elements is placed on the U-shaped portions of the lateral bars of the corresponding warming grill and beneath the middle bars.

13. The barbecue apparatus according to claim 1, wherein each of the cooking grills includes an upper lug for receiving the pivot of the corresponding supporting element.

14. The barbecue apparatus according to claim 2, wherein each of the cooking grills includes a lower lug for receiving a tip of the rod of the corresponding handle.

15. The barbecue apparatus according to claim 1, including a connector for connecting the cooking grills to each other.

16. The barbecue apparatus according to claim 15, wherein each of the cooking grills includes a lower lug for receiving the connector.

17. The barbecue apparatus according to claim 15, wherein the connector is a butterfly screw.

18. The barbecue apparatus according to claim 1, including at least one resilient lock connected to the casing, wherein the cover includes at least one lateral wall placed against the resilient lock when the cover is laid on the casing.

19. The barbecue apparatus according to claim 18, wherein the resilient lock includes an abutting portion secured to the casing and a guiding portion extending from the abutting portion.

20. The barbecue apparatus according to claim 19, wherein the guiding portion extending in a slat manner from the abutting portion that extends vertically.
